(19) United States
(12) Patent Application Publication
(10) Pub. No.: US 2005/0116390 A1
(43) Pub. Date: Jun. 2, 2005

(54) Method for injection molding

(75) Inventors: Kathy Lee Watson, Coconut Creek, FL (US); John Elliott Perry, Dania, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Nailite International, Miami, FL (US)

(21) Appl. No.: 10/930,005

(22) Filed: Aug. 30, 2004

Related U.S. Application Data
(60) Provisional application No. 60/499,315, filed on Aug. 29, 2003.

(51) Int. Cl. B29C 45/00

(52) U.S. Cl. 264/328.1; 264/328.18

(57) ABSTRACT

The invention provides a method for injection molding a wall covering comprising a plurality of panels, the method comprising the steps of: (a) providing a mold having a mold cavity therein, the mold cavity defining a wall covering comprising a plurality of panels, (b) providing a first precursor, the first precursor comprising a thermoplastic resin, (c) providing a second precursor, the second precursor comprising a thermoplastic resin and a filler, (d) mixing the first and second precursors in a controlled ratio to produce a precursor mixture, (e) melting the precursor mixture to produce a melted precursor mixture, (f) injecting the melted precursor mixture into the mold cavity, (g) cooling the melted precursor mixture contained in the mold cavity to a temperature sufficient for the melted precursor mixture to at least partially set and form the wall covering, and (h) releasing the wall covering from the mold.

### CROSS-REFERENCE TO RELATED PATENT APPLICATIONS

This patent application claims the benefit of U.S. Provisional Patent Application No. 60/499,315, filed Aug. 29, 2003.

### FIELD OF THE INVENTION

This invention pertains to a method for injection molding a wall covering and particularly to a method for injection molding a wall covering comprising a thermoplastic resin and a filler.

### BACKGROUND OF THE INVENTION

Injection molding is widely used as a means for producing a variety of articles from melt-processable materials, such as thermoplastic resins. In order to improve the physical and/or mechanical properties of such articles, a variety of additives often are added to the melt-processable material during the injection molding process. For instance, fillers can be added to a thermoplastic resin to limit the thermal expansion and contraction of the thermoplastic resin contained in the article, thereby stabilizing the dimensions of the article to temperature fluctuations. Typically, such fillers are provided in a bulk powdered or fibrous form, which can present several difficulties for the injection molding process.

Accordingly, several attempts have been made to facilitate the incorporation of such fillers into the melt-processable materials (e.g., thermoplastic resins) used in injection molding processes. For instance, injection molding apparatus have been developed which comprise a means for mixing the thermoplastic resin, which typically is provided in a pelletized form, and the powder or fibrous filler material immediately before the thermoplastic resin is melted and injected into the mold. While such apparatus do allow for the incorporation of the filler into the thermoplastic resin, the handling of a powdered or fibrous filler material often presents several challenges. In particular, when using such an apparatus, it can be difficult to achieve a homogeneous mixture of the thermoplastic resin and the filler during the plastication process, which can negatively impact the physical characteristics of the final article. Furthermore, the handling of large amounts of powdered or fibrous fillers requires specialized equipment and can produce environmental hazards due to high concentrations of airborne powder or fibers.

In order to alleviate the difficulties presented by handling and incorporating such filler materials into a thermoplastic resin, the manufacturers of thermoplastic resins have developed “compounded” thermoplastic resins for injection molding. The compounded thermoplastic resins comprise a mixture of a thermoplastic resin and a filler, which mixture is provided in the exact proportions to be used in the finished article. These compounded thermoplastic resins can then be directly fed into existing injection molding apparatus without further modification. While the use of compounded thermoplastic resins does allow for the production of an article without the need to handle bulk powdered or fibrous filler materials, the fees charged by manufacturers for compounding the thermoplastic resin are often high in relation to the cost of the raw materials (i.e., the thermoplastic resin and the filler). Accordingly, the costs associated with purchasing the volume of compounded thermoplastic resin needed to produce an article on a viable commercial scale often are quite high.

A need therefore exists for a method for injection molding of an article comprising a thermoplastic resin and a filler that addresses the costs associated with the compounding of thermoplastic resins and the challenges presented by the handling of the filler material. The invention provides such a method. These and other advantages of the invention, as well as additional inventive features, will be apparent from the description of the invention provided herein.

### BRIEF SUMMARY OF THE INVENTION

The invention provides a method for injection molding a wall covering comprising a plurality of panels, each panel having a body portion formed with simulated building elements, the method comprising the steps of: (a) providing a mold having a mold cavity therein, the mold cavity defining a wall covering comprising a plurality of panels, each panel having a body portion formed with simulated building elements, (b) providing a first precursor, the first precursor comprising a thermoplastic resin, (c) providing a second precursor, the second precursor comprising a thermoplastic resin and a filler, (d) mixing the first and second precursors in a controlled ratio to produce a precursor mixture, (e) melting the precursor mixture to produce a melted precursor mixture, (f) injecting the melted precursor mixture into the mold cavity, (g) cooling the melted precursor mixture contained in the mold cavity to a temperature sufficient for the melted precursor mixture to at least partially set and form the wall covering, and (h) releasing the wall covering from the mold.

### BRIEF DESCRIPTION OF THE DRAWINGS

FIG. 1 is a flowchart depicting the steps of a method for injection molding a wall covering according to the invention.

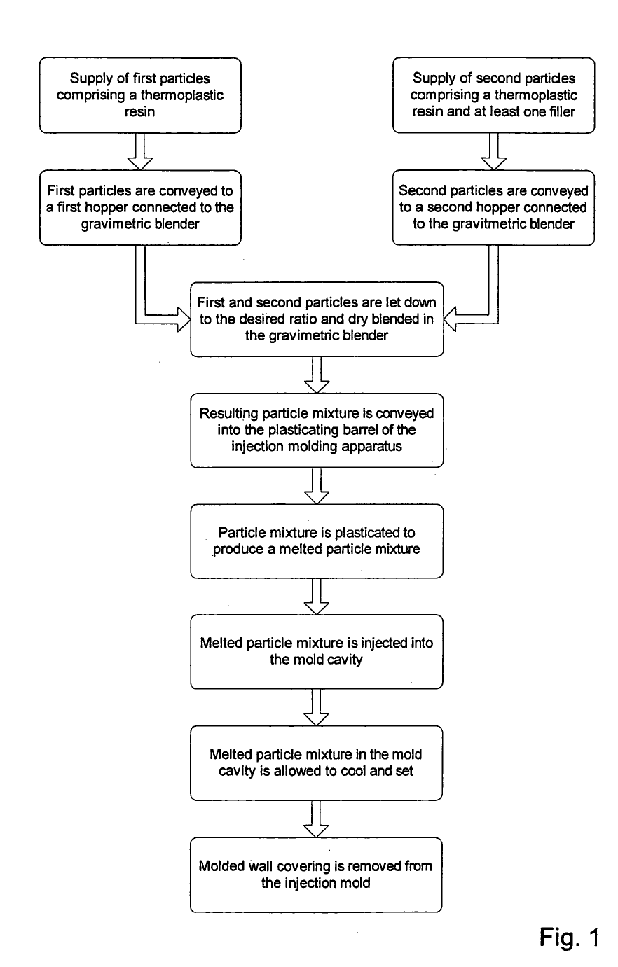

FIG. 2 depicts an injection molding apparatus suitable for practicing the method of the invention.

### DETAILED DESCRIPTION OF THE INVENTION

The invention provides a method for injection molding a wall covering comprising a plurality of panels, each panel having a body portion formed with simulated building elements, the method comprising the steps of: (a) providing a mold having a mold cavity therein, the mold cavity defining a wall covering comprising a plurality of panels, each panel having a body portion formed with simulated building elements, (b) providing a first precursor, the first precursor comprising a thermoplastic resin, (c) providing a second precursor, the second precursor comprising a thermoplastic resin and a filler, (d) mixing the first and second precursors in a controlled ratio to produce a precursor mixture, (e) melting the precursor mixture to produce a melted precursor mixture, (f) injecting the melted precursor mixture into the mold cavity, (g) cooling the melted precursor mixture contained in the mold cavity to a temperature sufficient for the melted precursor mixture to at least partially set and form the wall covering, and (h) releasing the wall covering from the mold.

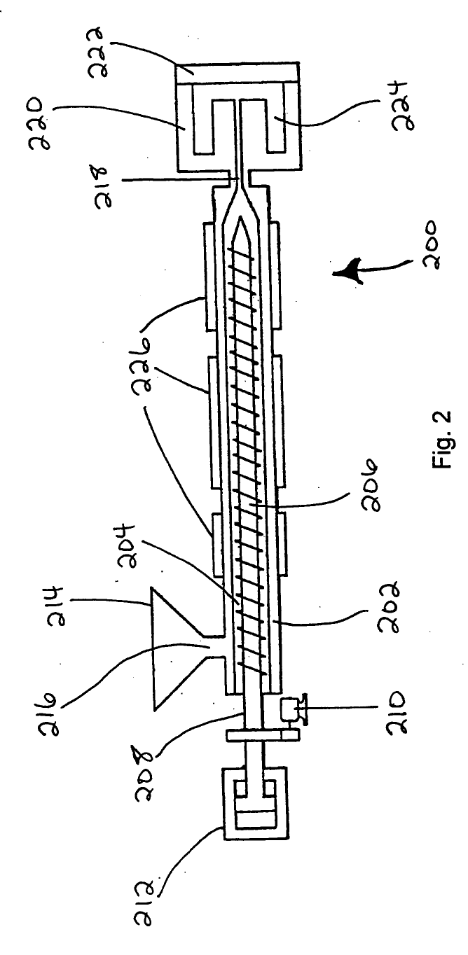

The method of the invention can be carried out on any suitable injection molding apparatus. FIG. 2 depicts an exemplary injection molding apparatus suitable for practicing the method of the invention. The injection molding apparatus 200 comprises a plasticating barrel 202 with a chamber 204 along the longitudinal axis of the barrel 202. A screw 206 is disposed within the chamber 204, which screw is rotatably and slidably mounted therein. The screw 206 is connected to a shaft 208 which is coupled to a source of rotary motion 210 generally indicated as a block on the diagram, but understood to be means well known in the art, such as an electric or hydraulic motor. A screw backpressure motor means 212, which is generally indicated in block form, also is connected to the shaft 208.

A feed hopper 214 is attached to the plasticating barrel 202, and the feed hopper 214 generally communicates with the chamber 204 through a feed orifice 216. The hopper 214 typically is disposed at the rearward portion of the plasticating barrel 202 and chamber 204. A nozzle 218 is located at the forward end of the barrel 202 and chamber 204, and the nozzle 218 generally communicates with a mold. The mold typically comprises a first mold element 220 and a second mold element 222, and the first and second mold elements, when mated, define a mold cavity 224 therein. One or more heaters 226 typically surround the plasticating barrel 202. When more than one heater is present, each heater 226 preferably is individually controllable so that the varying amounts or degrees of heat may be supplied along the length of the plasticating barrel 202.

As noted above, the method of the invention comprises providing a mold having a mold cavity therein. The mold cavity defines a wall covering comprising a plurality of panels, each panel having a body portion formed with simulated building elements. Suitable wall coverings include the wall coverings described in U.S. Pat. Nos. 5,072,562, 5,076,037, 5,249,402, 5,347,784, and 5,537,792. Generally, the mold is configured such that the mold cavity defines the wall covering in a substantially complete form. However, it will be understood that the wall covering produced by the method of the invention can also be subjected to further processing (e.g., machining) to provide the wall covering in its final form. Typically, the mold comprises a first mold element mated to a second mold element. When mated, the first and second mold elements define the mold cavity therebetween.

The method of the invention uses at least two separate precursors to form the mixture that is melted and injected into the mold cavity. Accordingly, the method of the invention comprises providing a first precursor and a second precursor. The first and second precursors can be provided in any suitable form (i.e., size and/or shape). Preferably, the first and second precursors are provided as particles, such as pellets. When the first and second precursors are provided in the form of particles, the first and second particles can be provided in any suitable form (i.e., size and/or shape).

The first precursor comprises a thermoplastic resin. Preferably, the first precursor consists essentially of, more preferably consists of, a thermoplastic resin. The thermoplastic resin of the first precursor can be any suitable thermoplastic resin. Suitable thermoplastic resins include, but are not limited to, polyolefin resins such as low-density polyethylenes, high-density polyethylenes, and polypropylenes, copolymers of olefins such as ethylene, propylene and other olefins, copolymers of olefin or olefins and other monomers such as vinyl acetate, acrylic acid, acrylic esters, styrene, vinyl chloride and other monomers, polystyrenes, polyvinyl chloride resins, polyvinylidene chloride resins, polymethyl methacrylate resins, acrylonitrile butadiene styrene resins, synthetic rubbers such as polybutadiene, polyisoprene, chloroprene and neoprene, polyamide resins, polyester resins, polycarbonate resins and the like. Typically, the thermoplastic resin is selected from the group consisting of polyolefins, polystyrenes, polyvinyl chloride, polyvinylidene chloride, polymethyl methacrylate, acrylonitrile butadiene styrene, synthetic rubbers, polyamides, polyesters, polycarbonates, mixtures thereof, and copolymers thereof. Preferably, the thermoplastic resin is selected from the group consisting of high-density polyethylene, low-density polyethylene, polypropylene, mixtures thereof, and copolymers thereof. Most preferably, the thermoplastic resin is a polypropylene copolymer.

The second precursor comprises a thermoplastic resin and a filler. The thermoplastic resin of the second precursor can be the same as set forth above for the first precursor. Preferably, the first and second precursors comprise the same type of thermoplastic resin (e.g., a polypropylene copolymer).

The thermoplastic resin of the first precursor and the thermoplastic resin of the second precursor each have a melt flow index. As utilized herein, the term “melt flow index” refers the rate of extrusion of a thermoplastic resin through an orifice at a prescribed temperature and load. Furthermore, as is understood by those of ordinary skill in the art, the melt flow index is inversely proportional to the viscosity of a thermoplastic resin at a specified temperature. The melt flow index of the thermoplastic resins can be measured using any suitable technique, provided the same technique is used to determine the melt flow index of the thermoplastic resin contained in each precursor. Typically, the melt flow index of the thermoplastic resin(s) is measured in accordance with ASTM Standard D 1238, entitled “Standard Test Method for Melt Flow Rates of Thermoplastics by Extrusion Plastometer.” Preferably, the melt flow index of the thermoplastic resin of the second precursor is greater than the melt flow index of the thermoplastic resin of the first precursor. While not wishing to be bound to any particular theory, it is believed that utilizing a second precursor comprising a thermoplastic resin having a higher melt flow index and lower viscosity than the thermoplastic resin of the first precursor allows for the filler contained in the second precursor to be more quickly and evenly dispersed when the precursor mixture is plasticated.

As noted above, the second precursor also comprises a filler. The filler contained in the second precursor can be any suitable filler (e.g., an inorganic filler). Typically, the filler is selected from the group consisting of carbon fiber, cellulose, glass beads, glass fibers, mineral fillers, and mixtures thereof. The filler preferably is a mineral filler. Suitable mineral fillers include, but are not limited to, aluminum hydroxide, alumina, barium sulfate, calcium carbonate, calcium silicate, calcium sulfate, clay, iron oxide, magnesium carbonate, basic magnesium carbonate, magnesium hydroxide, mica, silica, talc (i.e., hydrous magnesium silicate), wollastonite, and mixtures thereof. The mineral filler preferably is selected from the group consisting of calcium carbonate, talc, and mixtures thereof.

The filler (e.g., the filler particles or fibers) in the second precursor can have any suitable size. It will be understood that the function of the filler typically determines the size of the filler (i.e., the size of the filler particles or fibers). Accordingly, the preferred size of a filler used to control the thermal expansion/contraction of the thermoplastic resin may be different from the preferred size of a filler used to improve another physical property of the thermoplastic resin. Furthermore, the optimum particle size for a particular filler can be different than the optimum particle size of a different filler, even if both fillers are used for the same purpose. The filler typically has an average particle diameter of about 0.01 to about 200 μm, preferably about 0.01 to about 50 μm.

The second precursor can comprise any suitable amount of filler. It will be understood that the amount of filler that can be present in the second precursor can depend upon several factors, such as the particular filler and the particular thermoplastic resin, both of which can impact the friability of the precursor. Generally, the second precursor comprises about 1 wt. % or more (e.g., about 10 wt. % or more, about 20 wt. % or more, about 30 wt. % or more, or about 40 wt. % or more) of the filler. Preferably, the second precursor comprises about 50 wt. % or more, more preferably about 60 wt. % or more, even more preferably about 70 wt. % or more, and most preferably about 75 to about 85 wt. %, of the filler.

The first and second precursors can be mixed using any suitable means. Generally, the first and second precursor are mixed immediately prior to being introduced into the plasticating barrel of the injection molding apparatus. To that end, the first and second precursors typically are separately fed into a gravimetric blender. The gravimetric blender measures the amount of the first and second precursors necessary to produce the desired ratio, and then releases the first and second precursors into a mixing chamber, where the first and second precursors are mixed to produce the precursor mixture. The mixing chamber of the gravimetric blender generally is connected to the plasticating barrel of the injection molding apparatus. In particular, referring to FIG. 2, the gravimetric blender can be connected to the feed hopper 214, or the gravimetric blender can replace the feed hopper 214 and be directly connected to the feed orifice 216. In such an embodiment, the gravimetric blender feeds the precursor mixture directly into the plasticating chamber 204 through the feed orifice 216. Alternatively, the first and second precursors can be provided in two separate hoppers, which are connected to a means for controlling the flow of the precursors from the hoppers into the plasticating barrel of the injection molding apparatus. Then, as the plasticating barrel of the injection molding machine is charged (i.e., as the screw is rotated within the barrel and the chamber is filled with the appropriate amount of the precursor mixture), the first and second precursors pass from the hoppers into the plasticating barrel and chamber in the desired ratio. After the first and second precursors are conveyed into the plasticating barrel and chamber of the injection molding apparatus, the screw rotates within the chamber, thereby mixing the first and second precursors to produce a precursor mixture.

The first and second precursors can be mixed in any suitable ratio. Typically, the first and second precursors are mixed to provide a weight ratio of thermoplastic resin to filler in the melted precursor mixture of about 99:1 to about 1:1. Preferably, the first and second precursors are mixed to provide a weight ratio of thermoplastic resin to filler in the melted precursor mixture of about 1:1 to about 19:1, more preferably about 11:9 to about 9:1. In certain embodiments, such as when the filler is calcium carbonate, the first and second precursors are mixed to provide a weight ratio of thermoplastic resin to filler in the melted precursor mixture of about 1:1 to about 7:3, more preferably about 11:9 to about 13:7 (e.g., about 6:4). In certain other embodiments, such as when the filler is talc, the first and second precursors are mixed to provide a weight ratio of thermoplastic resin to filler in the melted precursor mixture of about 19:1 to about 3:1, more preferably about 9:1 to about 4:1 (e.g., about 17:3).

The precursor mixture is melted before it is injected into the mold cavity. The precursor mixture can be melted by any suitable means. Generally, at least one heater is attached to the plasticating barrel in such a way that it can heat the contents of the barrel (e.g., the precursor mixture). The heater can then be used to raise the temperature of the barrel to a point sufficient to melt the thermoplastic resin contained in the first and second precursors. Alternatively, the precursor mixture can be melted by the friction generated during the plastication of the precursor mixture. It will be understood that, as depicted in FIG. 2 and described above, the plastication of the precursor mixture typically is accomplished by a screw 206 which rotates within the plastication barrel 202 and chamber 204 of the injection molding apparatus 200. When the screw 206 is rotated, the precursor is forced against the inner walls of the plasticating barrel 202 and the flights of the screw 206, thereby subjecting the precursor to a shearing force. The friction generated by the shearing force often generates enough heat to at least partially melt the thermoplastic resin. In practice, the precursor mixture typically is melted by a combination of the heat supplied by at least one heater and the heat generated by the shearing force in the plasticating barrel.

The melted precursor mixture can be injected into the mold cavity by any suitable means. Typically, the melted precursor mixture is injected into the mold cavity by moving the screw within the plasticating chamber and along the longitudinal axis of the plasticating barrel. This movement of the screw serves to force the melted precursor mixture through a nozzle and into the mold cavity. Once the appropriate amount of the melted precursor mixture has been injected into the mold cavity, a constant pressure preferably is applied to the screw. This constant pressure ensures that the volume of melted precursor mixture in the mold cavity remains constant, even as the melted precursor mixture begins to contract as it cools within the mold cavity.

The melted precursor mixture contained in the mold cavity can be cooled using any suitable means. In particular, the melted precursor mixture can be cooled by allowing the heat to radiate to the surrounding environment (e.g., to the mold and the surrounding atmosphere). Alternatively, the mold can be connected to a means for cooling the mold and any material contained therein. For example, a coolant can be circulated through the body of the mold (e.g., through the body of the first and second mold elements). As noted above, the melted precursor mixture contained in the mold cavity is allowed to cool to a temperature sufficient for the melted precursor mixture (e.g., the thermoplastic resin in the melted precursor mixture) to at least partially set, thereby forming the molded article.

Once the melted precursor mixture has cooled to a temperature sufficient for the melted precursor mixture to at least partially set, the wall covering is released from the mold.

The wall covering produced by the method of the invention comprises a thermoplastic resin and a filler. It will be understood that the wall covering can further comprise other suitable additives, such as colorants (e.g., pigments or dyes), flame retardants, and UV stabilizers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for injection molding a wall covering comprising a plurality of panels, each panel having a body portion formed with simulated building elements, the method comprising the steps of:
(a) providing a mold having a mold cavity therein, the mold cavity defining a wall covering comprising a plurality of panels, each panel having a body portion formed with simulated building elements,
(b) providing a first precursor, the first precursor comprising a thermoplastic resin,
(c) providing a second precursor, the second precursor comprising a thermoplastic resin and a filler,
(d) mixing the first and second precursors in a controlled ratio to produce a precursor mixture,
(e) melting the precursor mixture to produce a melted precursor mixture,
(f) injecting the melted precursor mixture into the mold cavity,
(g) cooling the melted precursor mixture contained in the mold cavity to a temperature sufficient for the melted precursor mixture to at least partially set and form the wall covering, and
(h) releasing the wall covering from the mold.

2. The method of claim 1, wherein the thermoplastic resin of the first and second precursors is selected from the group consisting of polyolefins, polystyrenes, polyvinyl chloride, polyvinylidene chloride, polymethyl methacrylate, acrylonitrile butadiene styrene, synthetic rubbers, polyamides, polyesters, polycarbonates, mixtures thereof, and copolymers thereof.

3. The method of claim 2, wherein the thermoplastic resin of the first and second precursors is selected from the group consisting of high-density polyethylene, low-density polyethylene, polypropylene, mixtures thereof, and copolymers thereof.

4. The method of claim 3, wherein the thermoplastic resin is a polypropylene copolymer.

5. The method of claim 1, wherein the first precursor consists essentially of a thermoplastic resin.

6. The method of claim 5, wherein the first precursor consists of a thermoplastic resin.

7. The method of claim 1, wherein the thermoplastic resin of the first precursor has a melt flow index, the thermoplastic resin of the second precursor has a melt flow index, and the melt flow index of the thermoplastic resin of the second precursor is greater than the melt flow index of the thermoplastic resin of the first precursor.

8. The method of claim 1, wherein the filler is selected from the group consisting of carbon fiber, cellulose, glass beads, glass fibers, mineral fillers, and mixtures thereof.

9. The method of claims 8, wherein the filler is a mineral filler.

10. The method of claim 9, wherein the filler is selected from the group consisting of aluminum hydroxide, alumina, barium sulfate, calcium carbonate, calcium silicate, calcium sulfate, clay, iron oxide, magnesium carbonate, basic magnesium carbonate, magnesium hydroxide, mica, silica, talc, wollastonite, and mixtures thereof.

11. The method of claim 10, wherein the filler is selected from the group consisting of calcium carbonate, talc, and mixtures thereof.

12. The method of claim 11, wherein the filler is calcium carbonate.

13. The method of claim 11, wherein the filler is talc.

14. The method of claim 10, wherein the filler has an average particle diameter of about 0.01 to about 200 μm.

15. The method of claim 14, wherein the filler has an average particle diameter of about 0.01 to about 50 μm.

16. The method of claim 1, wherein the second precursor comprises about 60 wt. % or more of the filler.

17. The method of claims 16, wherein the second precursor comprises about 70 wt. % or more of the filler.

18. The method of claim 17, wherein the second precursor comprises about 75 to about 85 wt. % of the filler.

19. The method of claim 1, wherein the first and second precursors are mixed to provide a weight ratio of thermoplastic resin to filler in the melted precursor mixture of about 1:1 to about 19:1.

20. The method of claim 19, wherein the first and second precursors are mixed to provide a weight ratio of thermoplastic resin to filler in the melted precursor mixture of about 11:9 to about 9:1.
